(19) United States
(12) Patent Application Publication
(10) Pub. No.: US 2024/0092004 A1
(43) Pub. Date: Mar. 21, 2024

(54) Control Method, Control System and Computer Implemented Method for Determining a Predicted Weight Value of a Product Produced by an Injection Molding Device

(71) Applicant: Siemens Aktiengesellschaft, Muenchen (DE)

(72) Inventors: Anja VON BEUNINGEN, Erfurt (DE); Martin BISCHOFF, Aying Großhelfendorf (DE); Michel TOKIC, Tettnang (DE); Hans-Dimitri PAPDO TCHASSE, N¿rnberg (DE); Ingo GEIER, Cadolzburg (DE); Georgios VASIADIS, Erlangen (DE)

(21) Appl. No.: 18/368,699

(22) Filed: Sep. 15, 2023

(30) Foreign Application Priority Data
Sep. 16, 2022 (EP) 22196200

(51) Int. Cl. B29C 45/76

(52) U.S. Cl. CPC B29C 45/7693; B29C 2945/7613; B29C 2945/7629; B29C 2945/76949

(57) ABSTRACT

Control method, control system, computer-implemented method for determining a predicted weight value of a product produced by an injection molding device and a computer-implemented method for training a machine learning (ML) via an ML method, wherein the trained ML model is configured to determine the predicted weight value of the product produced via the injection molding device, where the method comprises recording and/or determining first production parameters of the injection molding device during production of a first product, recording and/or determining predecessor production parameters of the injection molding device during production of at least one predecessor product and each predecessor weight value of the at least one predecessor product, recording and/or determining a first weight value for the first product, and training the ML model, via a supervised learning method, with the first product parameters, further product parameters, at least one predecessor weight value, and the first weight value.

### BACKGROUND OF THE INVENTION

### 1. Field of the Invention

The present invention relates to a control method, a control system for an injection molding device and a computer-implemented method which determines at least one production parameter for a product produced via the injection molding device.

### 2. Description of the Related Art

European patent EP 3 691 855 B1 discloses an exemplary conventional method for determining process parameter curves for an injection molding device using a finite element simulation of the injection molding device. The determined process parameter curves are then used to control a flow rate of the injected plastic during operation of the injection molding device.

One disadvantage of the prior art is that only process parameters that have already been defined in advance of a production process can be taken into consideration when monitoring an injection molding production process. An injection molding production process is influenced by a large number of highly different process parameters. Consequently, it may be necessary to determine meaningful process parameter curves in separate, and generally complex, simulation test cycles for a particular injection molding process.

### SUMMARY OF THE INVENTION

In view of the foregoing, it is therefore an object of the present invention to provide a method and/or a device that enable and/or enables faster, simpler and/or more flexible monitoring and/or control of an injection molding process.

This and other objects and advantages are achieved in accordance with the invention by a computer-implemented method for training a machine learning (ML) model via an ML method, where the trained ML model is configured to determine a predicted weight value of a product produced via an injection molding device, where the method comprises recording and/or determining first production parameters of the injection molding device during the production of a first product, recording and/or determining predecessor production parameters of the injection molding device during the production of at least one predecessor product and each at least one predecessor weight value of the at least one predecessor product, recording and/or determining a first weight value for the first product, and training the ML model, via a supervised learning method, with the first product parameters, the further product parameters, the at least one predecessor weight value and the first weight value.

Due to the fact that it is possible to take into consideration even a large number of production parameters for training an ML model without a great deal of additional effort, it is possible to achieve simpler and/or more flexible monitoring of an injection molding process. By way of example, it is thus possible, via the described trained ML model, to train the ML model latter with a multiplicity of parameters, and then ultimately to use only a selection of process parameters operatively for the use of the ML model. Here, the number and selection of process parameters may be adapted flexibly using the same trained ML model.

The abovementioned method describes the training of a corresponding ML model. Further methods described and explained in the present disclosure concern the use of such a trained ML model within an injection molding device, what is known as inference using the ML model, and a corresponding control apparatus for the injection molding device.

A computer-implemented method in accordance with the present disclosure may, for example, run or be executed on a computing apparatus, in an electronic controller, in a control apparatus, in a controller, in an edge device, in a cloud and/or in a comparable computer apparatus. In this case, for example, a corresponding computer program product may be implemented on one or more of the electronic apparatuses and generate the method of the computer-implemented method when it runs or executes on this electronic apparatus.

In this case, after the training of an ML model in accordance with the disclosed method, the trained ML model may be stored in an electronic storage apparatus. Here, the electronic storage apparatus may, for example, form part of the electronic apparatus on which the ML model was also trained. Furthermore, the electronic storage apparatus may be an independent apparatus or else part of a further electronic apparatus according to the present description.

The first product may, in this case, be any product that can be produced or that has been produced using an injection molding device. Here, the first product may consist, for example, of any plastic material or comparable material that can be processed using an injection molding device. Such a material is, for example, polycarbonate or any combination of materials containing polycarbonate. The product may also consist of different materials or material components or material mixtures, provided they are suitable or are used for processing in an injection molding device.

One exemplary design for an injection molding machine 100, as illustrated schematically for example in FIG. 1, is described below. Exemplary control apparatuses 210 for the injection molding machine 100 are illustrated in FIGS. 2 and 3. The reference signs mentioned below refer to the accompanying figures.

The main assemblies of an injection molding machine 100 for thermoplastics processing are:
a plasticizing and injection unit 110,
a clamping unit 130 and
a controller 210,
   with the controller 210 nowadays often being installed in the machine bed of the injection molding machine 100 or in a switching cabinet next to the machine 100.

The plasticizing and injection unit 110 consists, inter alia, of a cylinder 112 having heating bands 118 for heating the cylinder 112, a screw 114, a nozzle 122, a reverse flow barrier (not illustrated in FIG. 1) and possibly a hopper 124 or granule container 124. The axles of this unit 110 may be operated hydraulically or electrically, inter alia.

The cylinder 112 is a tubular safety component that generally envelops a screw 114 and a reverse flow barrier (not illustrated in FIG. 1) and receives the cylinder head or pressure piston 116. The heating bands 118 generate the necessary heat, which, in conjunction with friction, leads to the melting of the plastic granules used to produce the corresponding product.

The screw 114 is located in the cylinder cavity. There are different screw embodiments depending on the application case and the plastic that is processed. However, a standard or three-zone screw has five tasks in terms of the granules, i.e., collecting, compressing, melting, homogenizing and injecting. The granules are first conveyed from the hopper 124 into the feed zone and are transported, by a rotating movement of the screw, in the direction of the nozzle 122. On their way forward, the granules are then compressed, vented and melted in a compression or transformation zone. The compressed, vented and melted granules then enter a discharge or metering zone, where they are further homogenized and compressed. Finally, the melt reaches a screw antechamber 120, where it is collected for injection.

During movement thereof, the granules come into contact with the inner cylinder wall. Heat is generated from this friction, which contributes to the melting and homogenization of the granules.

The hopper 124 performs, for example, the function of a granule container 124 that contains the granules of the plastic to be processed and is installed directly on the cylinder 112. However, this is optional, because it is possible to convey the material directly from a central material supply into the feed zone of the screw.

The clamping unit 130 comprises the tool 130 having a fixed tool half 132 and a movable tool half 134, and drive components (not illustrated in FIG. 1) for an opening and closing movement of the tool 130 through movement (symbolized by an arrow 136 in FIG. 1) of the movable tool half 134. The requirement for the tool drive is that it keeps the tool halves 132, 134 closed even at high injection pressures. The tool movement of the movable tool half 134 may be brought out mechanically, with a knee lever or a spindle, hydraulically and hydromechanically. In most cases, this movement is guided by columns that also carry the entire tool 130.

The tool 130 picks up the melt and distributes it. The tool 130 is also responsible for shaping and demolding the produced product, also called molded part. A sprue channel 138 picks up and distributes the melt. The sprue channel 138 constitutes the connection between the nozzle 122 and a cavity 140. The cavity 140 or the mold cavity 140 is a cavity generally formed between the tool halves 132, 134, which is filled with the melt during injection and in which the molding compound solidifies through a solidification process. The product to be produced is formed in this space. Temperature control channels (not illustrated in FIG. 1), which accelerate the cooling of the molding compound, are crucial for shaping. After the melt has cooled and the part has become hard, it is demolded, that is to say removed from the tool, by an ejector system (not illustrated in FIG. 1).

An exemplary processing cycle of an injection molding machine 100 is described below. The reference signs mentioned here refer to the accompanying figures.

The starting state for a plastic injection molding processing cycle is when the tool 130 is open, the plasticizing and injection unit 110 and the screw 114 are retracted to their respective rear end position, and the nozzle 122, if a seal is present, is closed, such that no material can flow from the cylinder 112. The tool 130 and the heating bands 118 are also set to the required temperatures. In this state, the screw antechamber 120 is filled with plastic melt.

In a first step, the tool 130 is closed and the clamping force is built up. This closing of the tool 130 is symbolized by an arrow 136 in FIG. 1. The plasticizing and injection unit 110 is moved in the direction of the tool 130, such that the nozzle 122 makes contact with the sprue 138 and both are connected with a high force. The nozzle 122 is then opened, in the case of a sealed nozzle 122, and the thermoplastic fluid is injected into the tool cavity 140 through a translational movement of the screw 114. This translational movement of the screw 114 is brought about by the movement of a pressure piston 116, and is symbolized by an arrow 126 in FIG. 1. The setting variable in this phase is usually the injection speed, which must be set high enough that the melt cools only in the cavity 140. Injection is complete when the cavity 140 is filled with melt.

As soon as the cavity 140 is full, the molding compound begins to cool, specifically from the surface inward. The volume of the molding compound decreases during cooling. For this reason, melt is forced further into the cavity to prevent shrinkage of the compound. This process occurs according to the specification of a desired pressure curve, with this “holding pressure”, as it is known, having to be set such that the tool clamping force is not overcome. The point in time at which the injection ends and the holding pressure phase just described begins is called the changeover point.

After the holding pressure phase, the plasticizing and injection unit 110 is retracted to its starting position, which in turn is symbolized by the arrow 126 in FIG. 1. To produce the next product, the granules are then supplied to the cylinder 112 and drawn in by the screw 114, melted and homogenized. In this process, the screw 114 moves rotationally and translationally backward in the opposite direction to the tool 130, while the melt collects in the screw antechamber 120. This phase is called plasticizing or dosing. The dosing volume should be higher than the volume required for the molded part. As a result, a small amount of the melt remains in the screw antechamber 120 after the injection and holding pressure phases. This residual volume is referred to as a residual compound cushion or simply (compound) cushion and is determined with the adjustment of the dosing path.

During the movement of the plasticizing and injection unit 110 and the plasticizing process, the molding compound cools in the cavity 140 such that the molded part is fully formed when the screw 114 is at its starting position. The tool 130 is thus opened and the molded part is removed or ejected from the mold. The opening of the tool is again symbolized by the arrow 136 in FIG. 1. The cycle is thereby complete and may be restarted.

Such an exemplary injection molding cycle thus comprises the following steps:
1. Start cycle—close tool;
2. Move plasticizing unit 110 forward;
3. Injection phase;
4. Holding pressure phase;
5. Move plasticizing unit 110 back;
6. Dosing;
7. Residual cooling time;
8. Open tool 130 and eject product—end cycle.

A machine learning (ML) method is understood to mean, for example, an automated or partially automated (“machine”) method that generates results not through rules that are fixed in advance, but rather in which patterns are identified (automatically) from a large number of examples via a learning algorithm or learning method, on the basis of which patterns it is then possible to make statements about data to be analyzed.

Such machine learning methods may be established, for example, as a supervised learning method, a semi-supervised learning method, an unsupervised learning method or else a reinforcement learning method.

Examples of machine learning methods are, for example, regression algorithms (for example, linear regression algorithms), generation or optimization of decision trees, learning methods for neural networks, clustering methods (for example, what is known as k-means clustering), learning methods for generating support vector machines (SVM), learning methods for generating sequential decision models or learning methods for generating Bayesian models or networks.

One example of a machine learning method is thus “linear regression”. Linear regression is a parametric method in which labels are approximated by weighting all features. In a standard variant of the linear model, the mean squared error (MSE) is minimized in the optimization. There are other variants of the linear model that differ according to the form of the error function. One variant, for example, is what is known as the Huber estimator, in which for example a parameter E is introduced to eliminate outliers in the inputs.

A further example of a machine learning method is the k-nearest-neighbor method. The principle of the k-nearest-neighbor (k-NN) model is that of determining the k nearest inputs for each input. It is a non-parametric method in which the similarity criterion is a defined metric. This metric may be a norm or a distance that can be determined for all inputs. The neighborhood of the labels is derived from the neighborhood or similarity of the inputs.

Decision trees are another example of an ML model on which a machine learning method is based. A decision tree (DT) is a hierarchical structure that may be used to implement a non-parametric estimation. In data processing using decision trees, the inputs are divided into local regions whose distance from one another is defined by a specific metric. These local regions are the leaves of the decision trees.

A decision tree is a sequence of recursive divisions that consists of decision nodes and end nodes or leaves. At each decision node, a defined function, i.e., the “discriminant function”, is used to make a discrete decision the result of which (yes or no) leads to the following nodes. If a leaf node is reached, then the process ends and an output value is delivered.

The result of such an application of such a machine learning algorithm or learning method to particular data is referred to, in particular in the present disclosure, as a machine learning model or ML model. Such an ML model in this case represents the digitally stored or storable result of applying the machine learning algorithm or learning method to the analyzed data.

The generation of the ML model may in this case be established such that the ML model is retrained by applying the machine learning method or a pre-existing ML model is changed or adapted by applying the machine learning method.

Examples of such ML models are results of regression algorithms (for example, a linear regression algorithm), neural networks, decision trees, the results of clustering methods (including, for example, the obtained clusters or cluster categories, definitions and/or parameters), support vector machines (SVM), sequential decision models or Bayesian models or networks.

Neural networks may, for example, be what are known as deep neural networks, feedforward neural networks, recurrent neural networks, convolutional neural networks or autoencoder neural networks. The application of corresponding machine learning methods to neural networks is in this case often also referred to as training of the corresponding neural network.

Decision trees may be configured, for example, as an “iterative dichotomizer 3” (ID3), classification and regression trees (CART) or random forests.

In addition, various categories of ML models may also be combined to form an overall ML model. Such a model combination (ensemble learning) is the linking of different ML models to achieve better inference. The combined ML models form an “ensemble”. There are various methods of how to merge models, and these may be combined via “voting”, “bagging” or “boosting”.

In addition, there is also additionally automated machine learning. Automated machine learning (AutoML) is a method via which an algorithm attempts, for given tasks or datasets, to determine the best learning strategy from a certain number of machine learning methods or ML models. In AutoML, the algorithm looks for the best preprocessing steps and the best machine learning methods or the best ensemble. AutoML may be combined with meta-learning. Meta-learning, also called learning to learn, is the science that systematically observes how different approaches to ML perform on a variety of learning tasks and then learns from these experiences (metadata) in order to learn new tasks much faster than would otherwise be possible.

The AUTO-SKLEARN software library offers a good implementation of AutoML. This system can form an ensemble of up to 15 estimators. In addition to this, up to 14 pre-processing methods for features and four pre-processing methods for datasets may also be used.

A neural network, at least in connection with the present disclosure, is understood to mean, for example, an electronic apparatus that comprises a network of nodes, where each node is generally connected to a plurality of other nodes. Furthermore, a neural network in connection with the present disclosure is also understood to mean, for example, a computer program product that is stored in a storage apparatus and that generates such a network in accordance with the present disclosure when it runs or executes on a computer. The nodes are also referred to, for example, as neurons or units. Here, each node has at least one input connection and one output connection. Input nodes for a neural network are understood to mean those nodes that can receive signals from the outside world (e.g., data, stimuli, or patterns). Output nodes of a neural network are understood to mean those nodes that can forward information, such as signals or data, to the outside world. “Hidden Nodes” are understood to mean those nodes of a neural network that are formed neither as input nodes nor as output nodes.

The neural network may in this case, for example, be configured as a deep neural network (DNN). Such a deep neural network is a neural network in which the network nodes are arranged in layers (the layers themselves being able to be one-dimensional, two-dimensional or higher-dimensional). Here, a deep neural network comprises at least two hidden layers, which comprise only nodes that are neither input nodes nor output nodes. In other words, the hidden layers do not have any direct connections to input signals or output signals.

What is known as deep learning is in this case understood to mean, for example, a class of machine learning techniques that utilizes many layers of non-linear information processing for supervised or unsupervised feature extraction and transformation and for pattern analysis and classification.

By way of example, the neural network may also have an auto-encoder structure. Such an auto-encoder structure may, for example, be suitable for reducing a dimensionality of the data and thus for example for recognizing similarities and common features.

A neural network may also be configured, for example, as a classification network, which is particularly suitable for dividing data into categories. Such classification networks are used, for example, in connection with handwriting recognition.

A further possible structure of a neural network may, for example, be the refinement in the form of a deep believe network.

A neural network may also have, for example, a combination of a plurality of the abovementioned structures. The architecture of the neural network may thus, for example, comprise an auto-encoder structure in order to reduce the dimensionality of the input data, which may then furthermore be combined with another network structure in order, for example, to recognize features and/or anomalies within the data-reduced dimensionality or to classify the data-reduced dimensionality.

The values describing the individual nodes and their connections, including further values describing a particular neural network, may be stored, for example, in a value set describing the neural network. Such a value set then constitutes a refinement of the neural network, for example. Such a value set may also be stored, for example, as part of a computer program that implements the neural network. If such a value set is stored following training of the neural network, for example, as part of a computer program implementing the neural network or separately, then a refinement of a trained neural network is stored, for example, with the entire stored computer program or value set. It is thus possible, for example, to train the neural network with corresponding training data in a first computer system, to then store the corresponding value set and/or the corresponding computer program that is associated with this neural network and to transfer it, as a refinement of the trained neural network, into a second system.

A neural network can generally be trained by determining parameter values for the individual nodes or for their connections using a wide variety of conventional learning methods by entering input data into the neural network and analyzing the then corresponding output data from the neural network. A neural network can thus be trained with known data, patterns, stimuli or signals in a conventional manner that is known per se, so as to then subsequently be able to use the thus-trained network for the analysis of further data, for example.

Training the neural network is generally understood to mean that the data with which the neural network is trained are processed in the neural network using one or more training algorithms so as to compute or to change bias values (bias), weighting values (weights) and/or transfer functions of the individual nodes of the neural network or of the connections between in each case two nodes within the neural network.

One of the conventional supervised learning methods may be used to train a neural network, for example, in accordance with the present disclosure. Here, through training with corresponding training data, a network is trained on results or capabilities respectively associated with these data. Furthermore, an unsupervised learning method may also be used to train the neural network. Such an algorithm, for example, generates, for a given number of inputs, a model that describes the inputs and permits predictions therefrom. In this case, there are, for example, clustering methods via which the data can be divided into different categories if they differ from one another, such as through characteristic patterns.

When training a neural network, supervised and unsupervised learning methods may also be combined, for example, if portions of the data are assigned trainable properties or capabilities, whereas this is not the case for another portion of the data.

Furthermore, reinforcement learning methods may also additionally be used to train the neural network, at least inter alia.

By way of example, training that requires relatively high computational power of a corresponding computer may be performed on a high-performance system, whereas further tasks or data analyses are can then still be performed on a lower-performance system using the trained neural network. Such further tasks and/or data analyses using the trained neural network may occur, for example, on an application module and/or on a control apparatus, a programmable logic controller or a modular programmable logic controller or other corresponding apparatuses according to the present description.

The training of the neural network may in particular be configured as supervised learning, for example. A deep neural network may be used here, for example. A deep-learning learning method may be used as the learning method, for example. Here, training data for training the neural network may be configured, for example, such that one or more recorded process parameters are assigned to a state or a parameter of the injection molding device, such as to a weight value of a produced product. These recorded one or more process parameters may, for example, be recorded at a certain point in time or may also have been recorded in a certain predefined or predefinable period of time. This assignment of a state or of a parameter to certain one or more sensor values is often referred to as what is known as labeling of the sensor data with said data.

Furthermore, the supervised learning may, for example, also be configured such that training data are formed such that one or more of the abovementioned parameters, such as weight values of manufactured products, are assigned to a time series of process parameters. In a comparable manner, time series of process parameters that originate from different sensors may also be assigned to one or more of the abovementioned parameters.

Machine learning and/or monitoring of a machine learning system work in two main phases: Training and inference.

Training an ML model refers to the process of using a machine learning algorithm to create the model. The training includes the use of a deep learning framework (for example, TensorFlow) and a training dataset. IoT data offer a source of training data that may be used by data scientists and engineers to train machine learning models for a variety of application cases, from fault detection to consumer intelligence.

Inference refers to the process of using a trained machine learning algorithm to make a prediction. IoT data may be used as input for a trained machine learning model and enable predictions that are able to control decision logic on the device, on the edge gateway, or elsewhere in the IoT system.

For use as an ML model or machine learning method within the scope of the present disclosure, it is possible to use, for example, a Huber estimator (a special regression method), an extra trees estimator (extremely randomized trees estimator; a combination of multiple decision trees generated by means of what is known as bagging), a histogram gradient boosting estimator or the abovementioned AutoML estimator or AUTO-SKLEARN estimator. For the abovementioned Huber estimator, extra trees estimator and histogram gradient boosting estimator, for example, corresponding algorithms are stored in the sklearn software library. For example, the AutoML estimator or the AUTO-SKLEARN software library is available via download from the Internet.

In this case, a weight value within the scope of the present disclosure may be, for example, a mass or a weight of a corresponding product or a value derived from such a mass and/or such a weight.

By way of example, the first weight value and the at least one predecessor weight value may be the weight value of a product taken from the corresponding tool after production in the injection molding machine. Furthermore, the weight value may also be a weight value of a product still located in the tool after the production process is complete. The weight values may also be, for example, a weight value of one or more corresponding intermediate products determined during the production process of the product.

Here, a weight value may be determined, for example, by weighing a corresponding product or intermediate product, for example, on a separate weighing apparatus or a weighing apparatus installed correspondingly in the injection molding machine or the tool, or a comparable sensor system. The weight value may furthermore also be determined by determining other product parameters of the produced product or intermediate product. By way of example, a volume of a corresponding product may thus be determined or estimated and then a weight value may be determined using a density of the product material that is used. Within the scope of the present disclosure, a weight value also comprises a volume value of a corresponding product or intermediate product.

A weight value of a product or intermediate product may also be determined, for example, by interpolation or extrapolation from further weight values with respect to the product, the further weight values having been determined for example following or in the course of the production process.

Production parameters with respect to the production of a product may be, for example, all measured values, machine parameters, component parameters and/or parameters of the injection molding machine that is used and/or its components that have been determined or measured before, during and/or after the production of the product. Furthermore, production parameters may also be all measured values and parameters with respect to a product or intermediate product that has been or is to be manufactured that have been determined or measured before, during and/or after the production of the product. Production parameters may furthermore also be measured and/or setting values of an environment of the injection molding machine, such as ambient temperature, air pressure, air humidity, brightness or comparable parameters. Production parameters may be determined, for example, by a corresponding sensor system within an injection molding machine or in the surroundings thereof. Furthermore, process parameters may also be computed based on such sensor values and/or determined via virtual sensors as part of a simulation of the injection molding machines, such as within the context of a digital twin.

Furthermore, production parameters may also be any predefined, predefinable or other control parameters that arise or have arisen before, during and/or after the production of a product in the context of the control of the injection molding machine in the course of the production of a product in question. Such control parameters may be, for example, collected, stored and/or output by a corresponding control apparatus in the context of the control of the production process of the product. Such control parameters may also be configured, for example, as setting values for an injection molding machine. These may be set, for example, by a user directly on the injection molding machine and/or entered, for example, via a human-machine interface (HMI), into a controller for an injection molding machine. Such control parameters may furthermore also be determined via a corresponding installation simulation and/or simulation of a control apparatus, such as in the context of a digital twin of the overall installation or the corresponding controller.

By way of example, a specific production parameter here may be a single value of this production parameter as was recorded and/or determined during the production of a corresponding product. A production parameter may furthermore also comprise a time series of values of this production parameter that was recorded in the course of the production of a corresponding product.

Examples of production parameters of an injection molding apparatus are:
Tool temperature,
Melt temperature,
Temperature of the heating zones,
Pressure at the nozzle,
   Screw position (linear and rotational) (for example through holding pressure),
Valve position of the nozzle,
Operating mode (dosing/post dec/ejection/injection/holding): has an effect inter alia on speed-based or pressure-based regulation,
Compound flowing through the spray nozzle,
Motor speed and torque during dosing,
Motor speed and torque during injection,
Force converted by the linear axle,
Position at the changeover point,
Force at the changeover point,
Material moisture,
Room temperature,
Room humidity,
Air pressure,
Temporal estimate of the overall linear energy conversion,
Holding pressure,
Injection pressure,
Injection speed,
Holding pressure time,
Injection time,
Sprue size,
Nozzle temperature,
Screw position,
Stagnation pressure.

Other examples of production parameters are (the brackets each contain an example of a unit of the production parameter):
Nozzle contact pressure—actual value (bar),
Residual moisture of granules—actual value (ppm),
Linear screw force—actual value (kN),
Linear screw force—reference value (kN),
Linear screw force at the changeover point—actual value (kN),
Linear screw force at the changeover point—reference value (kN),
Linear screw position—actual value (mm),
Linear screw position at the changeover point—actual value (mm),
Linear screw position at the changeover point—reference value (mm),
Motor torque during dosing—reference value (Nm),
Motor torque during dosing—actual value (Nm),
Motor torque during the filling process—actual value (Nm),
Motor torque during the filling process—reference value (Nm),
Motor speed during dosing—actual value (rpm),
Motor speed during dosing—reference value (rpm),
Motor speed during the filling process—actual value (rpm),
Motor speed during the filling process—reference value (rpm),
Process status—actual value
Radial screw position—actual value)(°,
Final weight of the injection-molded parts—actual value (g),
Ambient humidity—actual value (%),
Ambient air pressure—actual value (hPa),
Ambient temperature—actual value (° C.),
Zone temperatures (1 to 7)— actual value (° C.).

The ML model is configured, within the scope of the present invention, such that, after input of at least one selected production parameter, at least one weight value, inter alia, for a produced product is output, where the at least one selected production parameter comprises at least one parameter that was recorded in the course of the production of the produced product.

The predecessor product may, for example, be configured as a product that is structurally identical to the first product and that was produced earlier in time than the first product via the injection molding device. The predecessor product may furthermore also be configured as a product that is structurally identical to the first product and that was produced earlier in time than the production of the produced product on a device structurally identical or similar to the injection molding device.

The predecessor production parameters may, for example, be configured as production parameters that were recorded in the course of the production of the corresponding predecessor product. These may, for example, originate in this case from the injection molding device used for the production of the predecessor product, the correspondingly used control apparatus, and possibly associated user input and/or output apparatus, or be recorded or forwarded thereby.

The predecessor production parameters may, for example, be configured in this case such that a respective set of production parameters is contained in the predecessor production parameters for each of the at least one predecessor product.

The weight value may be established, for example, as a weight or a mass or a value derived from one or both values.

A weight value may be measured, for example, by a corresponding weighing device in an injection molding device or using an external weighing device. A weight value may furthermore also be given, for example, by a corresponding volume measurement, volume estimation or volume determination, by then, for example, using the volume directly as weight value or then, for example, determining the weight value using a density of the material that is used. Here, a corresponding volume may be determined and/or estimated, for example, using a quantity of the melt introduced into the corresponding tool, or using other known volume determination methods.

By way of example, the weight value may furthermore also be determined by simulating a production process of a product within a corresponding injection molding device.

The weight value may furthermore established, for example, as an individual value recorded or determined in relation to the respective product. Furthermore, the weight value may also be configured as a time series of corresponding weight values recorded and/or determined over a certain period of time in the course of the production of the respective product.

Here, for example, a weight value may be measured directly or derived from measured values. By way of example, a weight value of the first product may thus be measured and, based on the measured weight value, a first weight value of an intermediate product may be computed or determined during the production of the first product, and this first weight value may then be used as first weight value within the scope of the method in accordance with the present disclosure.

Furthermore, a weight value may also be determined, for example, as part of a simulation of the production of the product by the injection molding device. This may be performed, for example, via a virtual sensor or soft sensor defined as part of the simulation.

With the abovementioned options, it is also possible to determine corresponding time series for weight values during the production of the product. It is thus possible to determine a time series for a weight value, for example, via a simulation of the production process of an associated product by a corresponding injection molding device. By way of example, it is possible here to use a measured weight value of the produced product, or it is also possible to proceed without such a measured weight value. Furthermore, by way of example, it is possible to determine a time series for a weight value by estimating or simulating, interpolating or extrapolating corresponding weight values of intermediate products present during the production of the product from a measured weight value of a produced end product.

The training of the ML model via the supervised learning methods may, for example, be established such that the first production parameters along with the predecessor production parameters and the at least one predecessor weight value are entered into the ML model. The ML model then outputs a corresponding predicted weight value for the first product. The ML model is then trained via the recorded first weight value of the first product, for example, by determining an error value using the recorded first weight value and the predicted weight value and thus performing training of the ML model using one of the supervised learning methods.

The first production parameters, the predecessor production parameters and the at least one predecessor weight value are referred to here as input values or parameters or variables, while the first weight value is referred to as what is known as a label for these input values in the context of supervised learning.

In one embodiment of the invention, the method is furthermore configured such that the production parameters and/or the predecessor production parameters are recorded and/or determined at least in part via sensors of the injection molding device and/or control variables for the injection molding device and/or such that the first weight value of the first product and/or the at least one predecessor weight value of the at least one predecessor product are/is recorded and/or determined using a weighing apparatus.

The production parameters or predecessor production parameters may in this case, for example, be recorded at least in part using appropriate sensors of the injection molding device. Such sensors may be, for example, pressure sensors, temperature sensors, torque sensors, force sensors, flow sensors or comparable sensors.

In addition, the recording and/or determination of production parameters or predecessor production parameters may also be determined in full or in part through a simulation, interpolation or extrapolation.

Production parameters and/or predecessor production parameters may be established at least in part as values of virtual sensors. Here, virtual sensors may be defined or specified, for example, as part of a simulation of an injection molding device. Thus, for example, the injection molding device may be simulated based on certain input parameters, such as setting values and/or sensor values of real sensors of the injection molding device, and a corresponding value of a virtual sensor may then be determined as part of this simulation. Furthermore, values for such virtual sensors may also be computed analytically from measured sensor and/or setting values of the injection molding device.

Furthermore, the production parameters and/or the further production parameters and/or the first weight value and/or the at least one predecessor weight value may be recorded and/or determined at least in part by means of a computer-implemented simulation of the injection molding device.

Provision may also be made for the first weight value and/or the at least one predecessor weight value to be each assigned to a finished product removed or removable from the injection molding device.

Furthermore, in one alternative embodiment, the first weight value and/or the at least one predecessor weight value may also each be assigned to an intermediate product that arises in the course of the production of a product. Here, the first weight value may, for example, again be determined through a weight measurement or, for example, through a corresponding volume measurement and/or estimation, and optionally computed using a density of the material that is used. Furthermore, a corresponding weight value of such an intermediate product may also be determined, for example, by simulating a production process for a product in a corresponding injection molding device.

The first weight value and/or the at least one predecessor weight value may also each be formed as a time series of individual weight values. Here, a time series consists of at least two weight values recorded and/or determined during a production process of a product. In particular, a time series may consist of at least two weight values recorded and/or determined at different points in time during a production process of a product.

Furthermore, each individual weight value of a time series may be assigned to an intermediate product at a predefined or predefinable point in time in the course of the production of the respective product. Here, the individual weight values of a time series may each be ascertained for example through a weight measurement, a weight determination and/or a weight computation. Different weight values of a time series may in this case be determined in various ones of said ways (or even other ways). A weight may, for example, be determined, in accordance with the presently disclosed embodiments, through a simulation, for example, in the context of a digital twin of the corresponding injection molding device. The computation may be performed, for example, in accordance with the disclosed embodiments, from a measured, determined and/or estimated volume of a corresponding product or intermediate product, such as using a density of the product material.

The abovementioned objects and advantages in accordance with the invention is furthermore achieved by a computer-implemented method for determining a predicted weight value of a product produced via an injection molding device, where the method comprises recording and/or determining production parameters of the injection molding device during the production of the product, recording and/or determining predecessor production parameters of the injection molding device during the production of at least one predecessor product of the product and each at least one predecessor weight value of the at least one predecessor product, determining the predicted weight value of the product using an ML model trained via a method in accordance with the disclosed embodiments and using the production parameters, the predecessor production parameters and the at least one predecessor weight value.

Here, the method describes the use of an ML model trained in accordance with the disclosed embodiments for determining a product currently being produced. This use is also referred to as inference using the ML model.

Here, the production parameters, the recording and/or determination of the production parameters, the product, the injection molding device, the predecessor production parameters, the recording and/or determination of the predecessor production parameters and the at least one predecessor weight value and the at least one predecessor product may be configured in accordance with the disclosed embodiments.

The product may here in turn may be any product that can be produced or has been produced using an injection molding device. Here, products may consist, for example, of a wide variety of plastic materials or comparable materials that can be processed with an injection molding device. Such a material is, for example, polycarbonate or any combination of materials containing polycarbonate. The product may also consist of different materials or material components or material mixtures, provided that they are suitable or are used for processing in an injection molding device.

The predicted weight value may, for example, be determined such that the production parameters, the predecessor production parameters and the at least one predecessor weight value are used as input variables for the ML model, where the output of the ML model then comprises the predicted weight value. Here, for example, before entering the production parameters, the predecessor production parameters and the predecessor weight value, these may be adapted and/or prepared accordingly for entry into the ML model. Such an adaptation may comprise, for example, normalization, rescaling and/or other comparable input data preparation steps customary in the context of ML models.

Here, the method may, for example, be configured such that the predicted weight value is already determined during the production of the product. To this end, the method may, for example, be configured such that the production parameters of the injection molding device are recorded and/or determined up to one or more predefined or predefinable points in time during the production of the product and the predicted weight value is then determined immediately after this recording and/or determination or at a later time during the production of the product.

With this refinement, it is possible to predict a mass of a later end product even already during a production process of a product with the injection molding device. In the event of a deviation of this predicted mass from a predefinable or predefined target or desired mass for the product, it is then possible, already during the production of the product, for example, to intervene in the production parameters, control parameters or settings of the injection molding device that are used for production. Here, the production parameters and/or settings of the injection molding device may then, for example, be changed such that the mass of the product then produced to completion with the changed settings comes as close as possible to the desired or target mass of the product.

The abovementioned embodiment method therefore enables faster, simpler and/or more flexible monitoring and/or control of an injection molding process.

The computer-implemented method may for example run or be executed on a computing apparatus, in an electronic controller, in a controller, in an edge device, in a cloud and/or in a comparable computer apparatus. Here, for example, a corresponding computer program product may be implemented on one or more electronic apparatuses and generate or bring about the method of said computer-implemented method when it runs or executes on this electronic apparatus.

As such, after determining a predicted weight value in accordance with the disclosed embodiments of the method, the predicted weight value may be stored in an electronic storage apparatus. Furthermore, the predicted weight value may also be output to a user, or the determined predicted weight value may be communicatively transmitted to a further computer apparatus, computing apparatus, control apparatus or comparable electronic apparatus.

Following storage, output or communicative transmission of the predicted weight value, further processing of the predicted weight value may then take place. Such further processing of the predicted weight value may, for example, be configured as a computer-implemented method that comprises at least, inter alia, determining changed production parameters for the injection molding device.

The electronic storage apparatus may in this case, for example, form the part of an electronic apparatus on which the ML model was also trained. Furthermore, the electronic storage apparatus may also be part of a further electronic apparatus in according to the present disclosure.

The described computer-implemented method may furthermore be performed through training the ML model with the method in accordance with disclose embodiments using the production parameters and a product weight of a product manufactured in accordance with the present disclosure.

With this refinement, it is possible to further train the ML model, following the use of the ML model to predict a product mass of a product that has just been manufactured, with the corresponding data of this product. It is thereby possible to continue the training in parallel with the use of the ML model and thus to further improve the quality of a prediction of product weights using the ML model in accordance with the present disclosure in parallel with the use of the ML model. This makes it possible to monitor the monitoring and/or control of an injection molding process in an even faster, easier and/or more flexible manner.

In this case, the ML model may, for example, be trained such that a weight value of the manufactured product is determined in accordance with the present disclosure after production of the product. The ML model is then trained in accordance with the present disclosure using a supervised learning method with the production parameters recorded and/or determined during the production of the product, the recorded and/or determined predecessor production parameters, the at least one predecessor weight value as input data for the ML model, and the weight value of the manufactured product as a label or control variable.

The abovementioned objects and advantages in accordance with the invention are also achieved by a control method for controlling the production of a product via an injection molding device comprising starting a production sequence for producing the product with the injection molding device using starting control variables for the injection molding device, recording and/or determining current production parameters during the production sequence, determining a product predicted weight value using a computer-implemented method in accordance with the present disclosure using at least some of the current production parameters as production parameters in accordance with the present disclosure, determining changed control variables using a deviation of the product predicted weight value from a product reference weight value, continuing the production sequence for producing the product with the changed control variables, or starting a further production sequence for producing a further product using the changed control variables.

In this case, the product, the production of the product, the control of the production of the product, the injection molding device, the production parameters, the production sequence and the product predicted weight value may be configured in accordance with the present disclosure.

The abovementioned control method may also be configured as a computer-implemented control method. The computer-implemented control method may, for example, run or execute on a computing apparatus, in an electronic controller or control apparatus, a programmable logic controller, in a controller, in an edge device, in a cloud and/or in a comparable computing apparatus. Here, for example, a corresponding computer program product may be implemented on one or more of the electronic apparatuses and generate or perform the method of said computer-implemented method when it runs or executes on this electronic apparatus.

The abovementioned method makes it possible to control an injection molding device using an ML model in accordance with the present disclosure that has been trained in accordance with the present disclosure. Such a method likewise enables faster, simpler and/or more flexible monitoring and/or control of an injection molding process since, by virtue of using the ML model, which may, for example, be trained with a large number of production parameters, a large number and/or selection options of production parameters may be used for production monitoring with outlay remaining the same.

Here, the control method may preferably be configured as a computer-implemented control method. In particular, the control method may run or execute at least in part on a control apparatus for the injection molding device. Further parts of the control method may, for example, run or execute on a separate computing apparatus, a computer, an edge device and/or a specially configured additional module for the control apparatus. These further parts may, for example, be those parts of the control method that include the use of an ML model.

The control method may furthermore, for example, be established such that a change of control variables in accordance with the disclosed embodiments of the method during the production of a product leads to a better-quality product compared to the case of the original control variables being used in unchanged form until the product is finished. The term “better-quality” refers here to any improvement in product quality in terms of target weight of the product, material quality, product shape, product coloring, and/or comparable product characteristics.

In one advantageous embodiment, the control method may be performed in real time. Here, the control method may be implemented in a computing apparatus such that the control method is performed in real time when the control method runs or executes in the computing apparatus. The computing apparatus may in this case, for example, be a control apparatus, a computer, an edge device and/or a comparable computing and/or control apparatus.

The real-time method may, in this case, be implemented such that it is possible to guarantee a response time, for example, of less than 10 seconds, less than 1 second, less than 100 ms, less than 1 ms, or else less than 50 μs.

In this case, the product predicted weight value may be determined for example using at least some of the current production parameters and corresponding predecessor production parameters and the at least one predecessor weight value in accordance with the present disclosure.

Control variables are some of the production parameters, and may be all kinds of setting values for the injection molding device. By way of example, control variables may be control instructions, settings and/or comparable variables, data, information or instructions used or can be used for controlling and/or setting the injection molding device.

Examples of such setting values are injection speed, injection pressure, injection time, holding pressure, holding pressure time, residual cooling time, closing force, cooling temperature, cylinder temperatures, screw speed, stagnation pressure, decompression path and dosing path.

Here, for example, control variables or control instructions may be derived from predefined or predefinable setting values or (independently thereof) may be supplied to the injection molding device in order to the control same. Setting values may furthermore also be derived or have been derived from other control variables. Setting values may be supplied to the injection molding device, for example, via a user or by a corresponding control apparatus and may be implemented there, for example, directly, by an internal control apparatus or by an internal controller.

Control variables may be recorded, for example, via a corresponding control apparatus, which is configured to perform a control method in accordance with the present disclosure, and/or else an internal control apparatus of a corresponding injection molding device. Control variables may furthermore also be recorded, for example, via a corresponding user input/output device (for example, a human-machine interface (HMI)).

In accordance with the present disclosure, the product reference weight value is understood to mean a weight value that is assigned to the product to be produced by the injection molding device according to the present description. It constitutes a planned, predefined or intended weight value for the product. In particular, the product reference weight value constitutes a predefined or intended weight value for the product after the manufacturing carried out by the injection molding machine is finished, particularly after it has also been removed from the injection molding machine.

In this case, the product reference weight value may, for example, be determined from a template product via a weighing apparatus, where the template product serves as a model, prototype, design or template for the product to be produced.

Furthermore, the product reference weight value may also be determined, for example, from planning data or CAD data for the product. By way of example, a volume for the product to be produced may in this case be determined from the planning data or CAD data and may then be used, for example, directly as a weight value in the sense of the present disclosure, or is converted, for example, into a product reference weight value for the product to be produced via a density of a material that is used.

The product reference weight value may, for example, furthermore also be determined from a simulation of the injection molding device and/or the process running in the injection molding device. In this case, for example, the production of the product in the injection molding device may thus also be simulated such that a weight value for the produced product can be determined from the obtained simulation data. This may again be performed, for example, by determining a volume of the produced product via the simulation and determining, as a result thereof, the associated weight value, for example, in accordance with the above description.

The product reference weight value may furthermore also be predefined or can be predefined, for example, by a user or a corresponding product specification.

The deviation of the product predicted weight value from the product reference weight value may be established, for example, as a difference between these two values, as the absolute value of such a difference, as the square of such a difference or as any further mathematical quantity that is suitable for describing the deviation of the product predicted weight value from the product reference weight value.

In addition to the deviation of the product predicted weight value from the product reference weight value, at least one predecessor weight value in accordance with the present disclosure may additionally also be used to determine changed control variables. Here, for example, a deviation of the product predicted weight value from the product reference weight value and from the at least one predecessor weight value may be used to determine the changed control variables. It is thereby possible, for example, to take into consideration a certain dynamic when using changed control variables if the method described here is implemented multiple times in succession.

Within the scope of the present disclosure, determining changed control variables is understood to mean determining at least one changed control variable. Furthermore, several or else all control variables used by the injection molding device for the production of the product or of a further product may be changed in the course of determining changed control variables.

Determining changed control variables may comprise, for example, increasing or decreasing the pressure within the holding pressure phase or extending or shortening the holding pressure phase itself. This may be done such that the holding pressure phase is adapted in accordance with the deviation of the product predicted weight value from the product reference weight value.

Furthermore, determining changed control variables may comprise increasing or decreasing the melt temperature in order to reduce the deviation of the product predicted weight value from the product reference weight value. Experience has shown that such an increase or decrease in the melt temperature is too slow to be implemented in the ongoing production process of the product. Therefore, changed control variables that comprise such a change of the melt temperature are suitable, for example, for starting a further production sequence for producing a further product using these changed control variables.

Furthermore, the injection profile, comprising an injection pressure, an injection speed or an injection speed profile or an injection pressure profile, may be changed such that the deviation of the product predicted weight value from the product reference weight value is reduced. Such a change of control variables may occur instantaneously or almost instantaneously. Consequently, changed control variables that comprise such a change in the injection profile may be used both to continue the production sequence for producing the product with the changed control variables and to start a further production sequence for producing a further product using these changed control variables.

For example, the control variables may in this case be changed as mentioned by way of example below:

If the product predicted weight value is lower than the product reference weight value, then for example:
the injection pressure may be increased,
the injection speed may be increased,
the pressure value for the holding pressure may be increased,
the cylinder temperature may be increased,
the screw stagnation pressure may be increased,
the tool wall temperature may be increased, and/or
the holding pressure time may be extended accordingly.

Such a change of control variables may be used, for example, if one reason for an excessively low product predicted weight value is incomplete filling of the tool with the injection molding material.

If the product predicted weight value is too low because gas bubbles have formed in the product, changed control variables may be or comprise for example:

If the product predicted weight value is greater than the product reference weight value, for example, ridges and/or what are known as webs may form or have formed in the produced product. In this case, for example, a change of control variables may comprise for example:
a reduction in the cylinder temperature,
a reduction in the screw stagnation pressure,
a reduction in the screw speed, and/or
a reduction in the cylinder diameter.
an increase in the clamping force of the tool,
a reduction in the injection pressure,
a reduction in the pressure value for the holding pressure, and/or
an increase in the zone temperature for the melt.

The increase or decrease in a pressure or the extension of a certain application time, such as a holding pressure time, may be particularly implemented instantaneously. As a result, such a change of control variables is suitable both for continuing the production sequence for producing the product with changed control variables and for starting a further production sequence for producing a further product using the changed control variables.

If a change of the control variables comprises, for example, an increase in a melt temperature or a cylinder temperature, then a change of control variables that comprises such a change is particularly suitable in the event of starting a further production sequence for producing a further product using the changed control variables.

Further application possibilities for control variables and the absolute value of such a change may be found, for example, in the relevant specialist literature.

Changed control variables may be determined, for example, using appropriate tables or characteristic curves for different production parameters, setting variables and/or control variables. These may, for example, be stored digitally in a computing apparatus, control apparatus or similar device and be evaluated automatically. Changed control variables may also be determined, for example, using appropriate mathematical formulas or analytical methods. Such formulas may be found, for example, in the relevant specialist literature or from the relevant expert knowledge of a person skilled in the art of injection molding. Analytical methods may comprise, for example, extrapolation or interpolation of corresponding control variables from the past in connection with a deviation of the product predicted weight value from the product reference weight value to be achieved and, where applicable, corresponding deviations of the product predicted weight value from at least one predecessor weight value. Statistical methods may furthermore also be used here to determine changed control variables, at least inter alia.

Furthermore, it is also possible to use a control variable ML model, comparable to an ML model in accordance with the present disclosure, to determine changed control variables, which control variable ML model comprises, as an input variable, at least the deviation of the product predicted weight value from the product reference weight value and has, as an output parameter, at least one changed control variable, preferably at least one particularly suitable changed control variable. Such a control variable ML model may then be trained, for example, using data from corresponding test series in which dependencies of deviations of product predicted weight values from corresponding product reference weight values are determined based on production parameter changes.

The continuation of the production sequence for producing the product with changed control variables may in this case established such that the control variables are changed during the ongoing operation of the production sequence for producing the product such that no interruptions in the production sequence arise. Furthermore, the continuation of the production sequence for producing the product with changed control variables may be established such that any interruptions in the course of the change of the control variables are configured such that there are no significant effects of such interruptions on a quality of the produced product in the context of a desired product quality. Permissible interruptions may in this case depend, for example, on a desired product quality.

The starting of a further production sequence for producing a further product using the changed control variables may be configured such that, after the production of the product with the starting control variables, a corresponding change is made to the control variables and the further product is then produced using the changed control variables.

In one alternative embodiment, the method the control variables are already changed during the production of the product, and the further product is then likewise already produced in part with the changed control variables.

In one advantageous embodiment, the control method may be performed in real time or is configured to be performed in real time.

Provision may in particular be made for the method to be performed or can be performed in real time in the context of the control of an injection molding machine.

This embodiment of the control method makes it possible to react to a corresponding deviation already during the production of a product or multiple products and thus to enable faster, simpler and/or more flexible monitoring and/or control of the injection molding process.

Real-time is understood to mean the operation of a computing system, regulation system or control system in which programs for processing data that arise are continuously operational such that the processing results are available within a predefined period of time or response time (see, for example, DIN ISO/IEC 2382 or DIN 44300).

Depending on the application case, the data may arise in a temporally random distribution or at predetermined points in time. The hardware and software must ensure that there are no delays that could prevent compliance with this condition. The data do not in this case have to be processed particularly quickly; the processing only has to be guaranteed to be fast enough for the respective requirements of the respective application. Depending on the application case, the data may arise in a temporally random distribution or at predetermined times.

A real-time operating system is understood to mean an operating system for a data processing apparatus configured such that requests of a user program, or even a signal arriving via a hardware interface, can be processed reliably within a period of time that is defined or definable in advance. It is essential here that there is such a period of time that can be assured in the first place. The length of this period of time is not essential to the fact that a particular operating system is a real-time operating system.

By way of example, a real-time operating system may be configured as a real time operating system in the sense of DIN 44300.

By way of example, the abovementioned period of time or guaranteed response time may be 10 seconds, 1 second, 100 ms, 1 ms, or even 50 μs or less.

In this case, the control method may be performed in real time such that an interruption in the method during the course of changing the control variables, or the control parameters, does not exceed the response time guaranteed according to real-time specifications. Furthermore, the control method may be configured such that the period of time between the determination of the product predicted weight value and a change of the control variables does not exceed the response time guaranteed according to real-time specifications. The control method may also be configured such that the period of time between the determination of the product predicted weight value and a continuation of the process sequence for producing the product with the changed control variables does not exceed the response time guaranteed according to real-time specifications.

If a control program with cyclic program execution is used in the context of the control method, then the execution of the control method in real time may be configured such that the cycle time, as it is known (cycle time: the time to run a program cycle of the control program), is less than or equal to the maximum response time prescribed according to real-time specifications. The control method may in this case, for example, be configured such that, when determining the changed control variables in a first cycle of the program sequence of the control program, the production sequence is continued with the changed control variables in a second cycle of the program sequence of the control program. Provision may be made in this case for the second cycle of the program sequence to directly follow the first cycle of the program sequence. Provision may furthermore be made for there to be a predefined or predefinable number or minimum number of cycles of the program sequence between the first and second cycle of the program sequence.

The abovementioned objects and advantages in accordance with the invention are also achieved by a control system for controlling an injection molding device, where the injection molding device is designed and configured to produce a product, where the control system is configured to control the injection molding device via a control method in accordance with the present disclosure.

The control system may, for example, comprise a control apparatus that is configured to control the injection molding device. Here, for example the product predicted weight value and also the changed control variables may be determined within the control apparatus.

Furthermore, the product predicted weight value and/or the changed control variables may also be determined in a further computing apparatus. This further computing apparatus may be configured, for example, as a computer, a further control apparatus, an edge device or else an application module for the control apparatus. Here, the product predicted weight value and the changed control variables may be determined in the same further computing apparatus or in different ones.

The control apparatus may be any type of computer or computer system that is configured to control an apparatus or device. The controller may also be a computer, a computer system or as a cloud, on which control software or a control software application, such as a control application, is implemented or installed. Such a control application implemented in the cloud may be established, for example, as an application having the functionality of a programmable logic controller.

The control apparatus may furthermore also be configured as an edge device, where such an edge device may, for example, comprise an application for controlling devices or installations. By way of example, such an application may be configured as an application having the functionality of a programmable logic controller. The edge device may in this case, for example, be connected to a further control apparatus of a device or installation or directly to a device or installation to be controlled. The edge device may furthermore be configured such that it is additionally also connected to a data network or a cloud or configured to be connected to a corresponding data network or a corresponding cloud.

The control apparatus may, for example, also be configured as a programmable logic controller (PLC). The safety-oriented control apparatus may furthermore also be configured as what is known as a modular programmable logic controller (modular PLC).

A programmable logic controller, PLC for short, is a component that can be programmed and used to regulate or to control an installation or machine. Specific functions such as flow control may be implemented in programmable logic controllers, such that both the input signals and the output signals of processes or machines can thereby be controlled. The programmable logic controller is defined for example in the European Standard (EN) 61131 and/or International Electrotechnical Commission (IEC) 61499 standard.

In order to connect a programmable logic controller to the installation or machine, both actuators that are generally connected to the outputs of the programmable logic controller and sensors are used. Status displays are also used. The sensors are generally located at the PLC inputs, where the programmable logic controller uses them to obtain information about what is going on in the installation or machine. Sensors include, for example, light corridors, limit switches, buttons, incremental encoders, fill level sensors and/or temperature sensors. Actuators include, for example, contactors for switching on electric motors, electric valves for compressed air or hydraulics, drive control modules, motors and/or drives.

A PLC may be implemented in various ways. In other words, it may be implemented, for example, as a single electronic device, as a software emulation, as a virtual PLC or soft PLC, or as a PC plug-in card. Modular solutions in which the PLC is constructed from multiple plug-in modules are often also encountered. Such modules may be or comprise, for example, a central control module, an input-output module, a communication module, a converter module, an application module or comparable modules.

A virtual PLC or a “soft” PLC is understood to mean a programmable logic controller that is implemented as a software application and that can run or that runs (executes) on a computer apparatus, an industrial PC or other PC, a computing apparatus or, for example, also an edge device. In this case, there is also the option to execute a virtual PLC or soft PLC in a modular manner. Here, individual functionalities of a programmable logic controller or PLC are then formed as individual software modules, which are connected or connectable to one another, for example, via middleware and/or an internal data bus. Such modules may be, for example, a central control software module (for example, comprising at least inter alia the properties and capabilities prescribed by the IEC 61131 standard), a communication module for coupling to a field bus, a communication network, to certain apparatuses or devices, to an Ethernet, an Open Platform Communications United Architecture (OPC UA) or comparable communication networks, a web server module, a human machine interface (HMI) module and/or an application module according to the present description.

A modular programmable logic controller may in this case be configured such that multiple modules may be or are provided, where, as a rule, one or more expansion modules may be provided in addition to a central module that is configured to run or execute a control program, for example, for controlling a component, machine or installation (or part thereof). Such expansion modules may be configured, for example, as a current/voltage supply or for inputting and/or outputting signals or furthermore also as a function module or application module for taking on special tasks (for example a counter, a converter, data processing with artificial intelligence methods).

By way of example, a function module or application module may also be designed as an artificial intelligence (AI) module for performing actions using AI methods or ML methods. Such a function module may, for example, comprise a neural network or an ML model in accordance with the present disclosure or a control variable ML model in accordance with the present disclosure.

By way of example, an edge device may comprise an application for controlling devices or installations. By way of example, such an application may be configured as an application having the functionality of a programmable logic controller. The edge device may in this case, for example, be connected to a further control apparatus of a device or installation or else directly to a device or installation to be controlled. The edge device may furthermore be configured such that it is additionally also connected to a data network or a cloud or be configured to be connected to a corresponding data network or a corresponding cloud.

An edge device may furthermore be configured to implement additional functionalities in connection with the control for example of a machine, installation or component—or parts thereof. Such functionalities may be for example:
collecting data and transferring them to the cloud and/or performing appropriate pre-processing, compression and/or analysis of such data;
analyzing data for example using AI methods, for example using neural networks or corresponding ML models. By way of example, the edge device may comprise an ML model for this purpose.
managing or training a neural network or ML model.

The training itself may in this case occur at least in part in the edge device itself, or at least inter alia also in a cloud. If training occurs in a cloud, then the edge device may be configured, for example, to download the trained neural network or ML model and subsequently to use it.

By way of example, an application module may be configured as a hardware module. Such a hardware module may, for example, be configured as a structurally independent module. Such a structurally independent hardware module may, for example, have a housing and/or mechanical elements or devices for coupling to the control apparatus or for mechanical integration into the control apparatus.

An application module may furthermore be configured as a software module. In this case, for example, a control apparatus may comprise this software module and the control apparatus may furthermore be configured to execute this application module in the form of a software module.

In one advantageous embodiment, an application module is part of the control apparatus. In this case, for example, the application module may belong logically to the control apparatus. Furthermore, the application module may be coupled mechanically to the control apparatus or integrated mechanically into the control apparatus. The application module may also be configured as a software application, where the control apparatus may then comprise the application module in the form of a software application.

An application module may be configured as a freely programmable application module. Freely programmable firmware makes it possible to provide a freely programmable or independently programmable application or app, which is executed as part of the firmware and/or is executed as part of a runtime environment provided by the application module.

A freely programmable application module may be configured, for example, to execute software or programs that are created and executed in a programming language that is not supported by the other control apparatus or the remaining components and/or modules of the control apparatus. In particular, a freely programmable application module may be configured, for example, to execute software or programs that are created and/or executed in a programming language that are not defined as programming languages for such apparatuses by the IEC 61138 IEC standard or comparable standards with regard to control apparatuses and/or programmable logic controllers.

In one advantageous embodiment, a freely programmable application module is not configured to run programs that have been or are created in a programming language according to IEC 61131, IEC 61499 or a comparable standard. These are the following programming languages: Instruction List (IL), Ladder Diagram (LD), Function Block Diagram (FBD), Sequential Function Chart (SFC) and Structured Text (ST).

A freely programmable application module for a control apparatus may, for example, be configured such that it runs or executes a software application in addition to a control program, running or executing in the control apparatus, for controlling the machine or installation. Such a freely programmable application module makes it possible to implement a functionality of the control apparatus in addition to a standard control functionality that is implemented, for example, by a central control module for the control apparatus. The central control module may, for example, be configured to run or execute the control program for controlling the machine or installation. The central control module may, for example, also be configured according to the IEC 61131, IEC 61499 standard and/or comparable standards of commonly programmable logic control apparatuses or at least comprise such a functionality.

Examples of such application modules may be, for example, hardware or software modules for executing machine learning applications. Other examples of such application modules are, for example, hardware or software modules for implementing Boolean processors, for implementing or performing simulations or the running of simulation programs, for programming or executing mathematical algorithms, analytical methods or big data analyses, for running standalone programs in one or more predefined programming languages (for example, C, C++, and/or Python) or comparable applications.

A control system in accordance with the present disclosure may furthermore be configured for real time execution of the control method in accordance with the disclosed embodiments. To this end, the control system may for example comprise a control apparatus for controlling the injection molding device that comprises, at least inter alia, a real time operating system in accordance with the present disclosure.

If the control system comprises multiple hardware components, then the control system may furthermore be configured such that these hardware components are configured and interact so as to ensure real-time execution of a control method in accordance with the disclosed embodiments.

Furthermore, the control system may comprise an edge device that is configured to determine a product predicted weight value in accordance with the present disclosure and/or to determine changed control variables in accordance with the present disclosure. The edge device may in this case be configured in accordance with the present disclosure.

The control system may, for example, comprise a programmable logic controller that and configured to control the injection molding device via a control method in accordance with the present disclosure. Here, the programmable logic controller may comprise an application module that is configured to determine the product predicted weight value in accordance with the present disclosure and/or to determine changed control parameters in accordance with the present disclosure. The programmable logic controller and the application module may in this case, for example, be configured in accordance with the present disclosure.

The application module may in this case, for example, be configured as an AI module or ML module for implementing actions using AI methods or ML methods or can comprise such a functionality. Such an application module may, for example, comprise a neural network or an ML model in accordance with the present disclosure.

The application module may furthermore also be configured to implement or perform simulations or the running of simulation programs, to program or execute mathematical algorithms and analytical methods, or else as a freely programmable application module, or can comprise such functionalities.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is explained in more detail by way of example below with reference to the accompanying drawings, in which:

FIG. 1 shows a schematic illustration of an exemplary injection molding machine;

FIG. 2 shows a first exemplary control system for controlling the injection molding machine of FIG. 1;

FIG. 3 shows a second exemplary control system for controlling the injection molding machine of FIG. 1;

FIG. 4 is a flowchart of computer-implemented method for training a machine learning (ML) model via an ML method in accordance with the invention; and

FIG. 5 is a flowchart of a control method for controlling production of a product via an injection molding device in accordance with the invention.

### DETAILED DESCRIPTION OF THE EXEMPLARY EMBODIMENTS

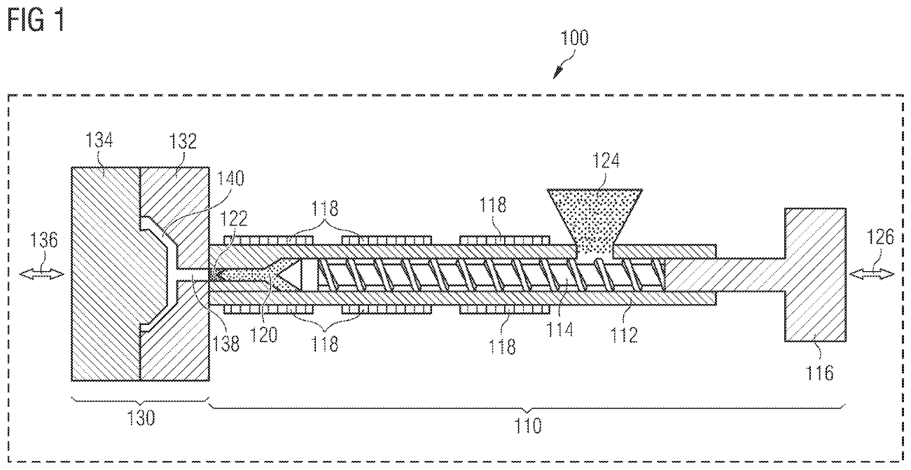

FIG. 1 shows a schematic illustration of an exemplary injection molding machine 100.

A description and further explanations in relation to the injection molding machine 100 illustrated by way of example in FIG. 1 may already be found in the above description in the context of the general description of injection molding machines and exemplary injection molding methods.

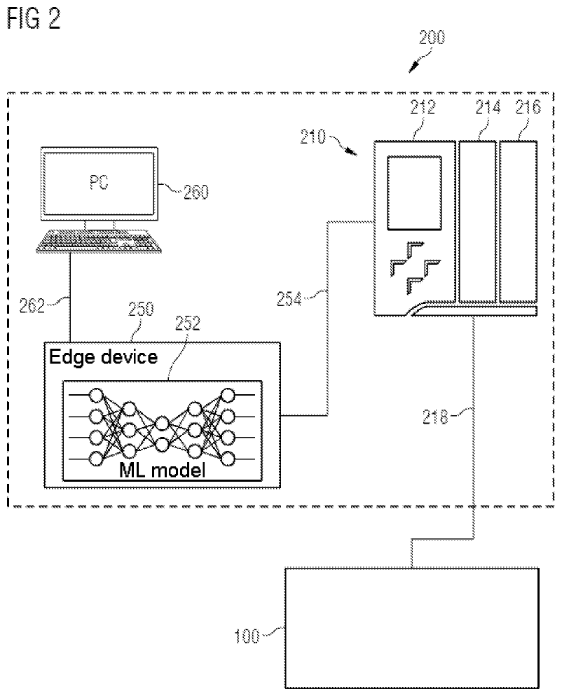

FIG. 2 shows a schematic illustration of the injection molding machine 100 already explained in connection with FIG. 1 and the present disclosure, with a control system 200 for controlling the injection molding machine 100.

The control system 200 comprises a control apparatus 210 that is configured, in the exemplary embodiment shown in FIG. 2, as a programmable logic controller (PLC) 210. Here, the programmable logic controller 210 comprises a central module 212 that is configured to run or execute a control program for controlling the injection molding machine 100, and also two input-output modules 214, 216. The input-output modules 214, 216 and the central module 212 are communicatively connected to one another via a backplane bus (not illustrated in FIG. 2). The first of the input-output modules 214 is also connected to the injection molding machine 100 via a field bus connection 218.

When a control program for controlling the injection molding machine 100 is run or executed in the central module 212, corresponding control instructions are generated and are then output to the injection molding machine 100 via the first input-output module 214 and the field bus connection 218. Corresponding sensor values or other information from the injection molding machine 100 are in turn communicated back, via the field bus connection 218 and the first input-output module 214, to the central module 212 of the programmable logic controller 210. These sensor values or other information from the injection molding machine 100 may then be used there, for example, as input variables for the control program running (executing) in the central module 212.

The control apparatus 210 is furthermore connected, via an Open Platform Communications United Architecture (OPC UA) communication connection 254, to an edge device 250, which is configured as an industrial PC 250, comprising a corresponding edge operating system. The edge device 250 comprises a neural network 252 that is configured, at least, inter alia, to determine a product predicted weight value in accordance with the present disclosure.

The edge device 250 is furthermore connected in turn to a PC 260 via an OPC UA communication connection 262, where the PC 260 is designed and configured as an operator and/or user interface (human machine interface (HMI)) or user input-output device for the edge device 250 and the control apparatus 210.

The control system 200 is now configured such that control parameters or control variables for the injection molding machine 100 can be dynamically adapted to a deviation of a predefinable or predefined product target mass from a product mass predicted in the current production process. Here, the product target mass is one exemplary embodiment of a product reference weight value in accordance with the present disclosure.

For this purpose, the neural network 252 has been trained such that it is configured to predict a product mass achieved or achievable in the current production process. To this end, process parameters in the course of the production of a first product and process parameters in the course of the production of at least one predecessor product to this first product have been recorded and used as input values for such training, while a measured mass of the first product after completion thereof has been used as label for these data. The neural network 252 is thereby able, after inputting of process parameters of a first product that is to be produced, which has been produced or that is in production, to predict a first predicted mass of this first product.

In the current production process, a target mass for the products to be produced is now known. This target mass was determined, for example, via corresponding example products or else from CAD data for the product.

During the production of a product in the injection molding machine 100, current sensor and machine parameters of the injection molding machine 100 are now transmitted continuously to the control apparatus 210 via the field bus connection 218 and, together with corresponding control parameters of the control apparatus 210, transmitted to the edge device 250 via the OPC UA communication connection 254. These data constitute one example of process parameters in accordance with the present disclosure and are entered into the neural network 252 together with corresponding process parameters of predecessor products produced before the product currently being produced and the respective product masses achieved in the process. An output variable of the neural network 252 is then a predicted product mass for the product currently in production.

The edge device 250 is furthermore configured to compute a difference between the predicted product mass determined in this way and the target mass applicable to the product. Based on corresponding control parameter tables stored in the edge device 250, changed control parameters are then determined, in the event of using which it is expected that the mass of the product that has just been produced corresponds to the target mass or at least comes closer to the target mass.

For the next product to be produced, the changed control parameters are then used right from the outset and the abovementioned method sequence is performed again.

This method sequence is performed until there is no, or only a tolerable, deviation of the current product mass from the target mass for the product to be produced. The control parameters that are then determined are then used for the production of the subsequently produced products.

At regular time intervals, a deviation of the current mass of a product that has just been produced from the desired target mass may then also be measured and, if deviations are identified, then the abovementioned process sequence may be restarted. The control parameters may thereby also be continuously updated during ongoing operation of the injection molding machine 100 with the proposed method. This makes it possible for example to compensate for a creeping change or drift in machine, material and/or environmental parameters.

In one alternative embodiment, the changed control parameters may also, for example, be determined in the edge device 250 via a second neural network. This second neural network has been trained in this case such that, after input of a deviation of a product predicted mass from a product target mass and the current control parameters (and possibly further process parameters) changed control parameters or change values for control parameters are output.

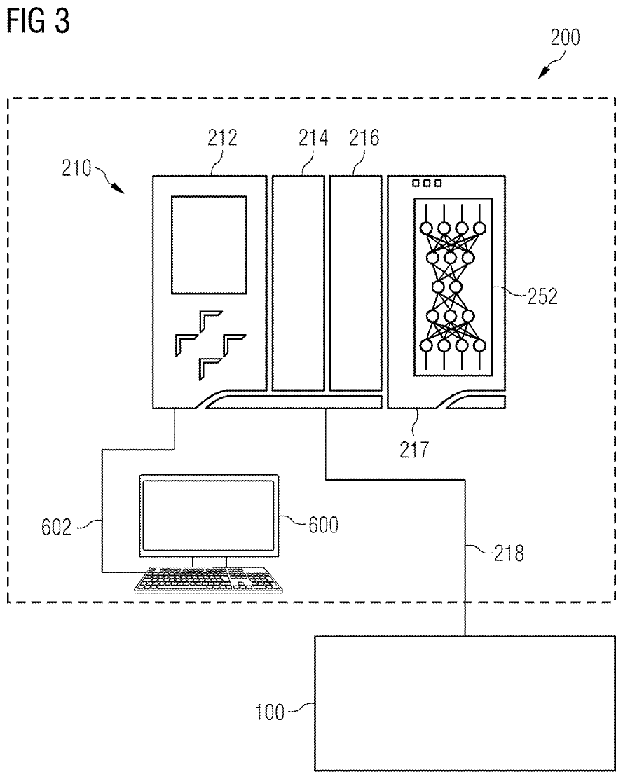

FIG. 3 shows an alternative embodiment of the control system 200, where the control apparatus 210 is in turn configured as a programmable logic controller. Instead of the edge device 250 in FIG. 2, the programmable logic controller 210 illustrated in FIG. 3 comprises an application module 217, which is configured as an ML module (ML: machine learning, or machine learning method) 217. The ML module 217 in this case comprises a neural network 252, as has already been explained in connection with FIG. 2. The ML module 217 is likewise connected to the other modules 212, 214, 216 of the PLC 210 via the backplane bus of the PLC 210. The application module 217 may in this case furthermore be configured in accordance with the present disclosure

FIG. 3 furthermore again shows the PC 600, which, as in the example shown in FIG. 2, is configured as a user interface for operating the PLC 210, the application module 217 and/or the injection molding machine 100. To this end, the PC 600 is connected to the PLC 210 via a communication connection 602, for example, via OPC UA.

In the exemplary embodiment illustrated in FIG. 3, the application module 217, with respect to the control method presented here, comprises the functionality provided by the edge device 250 in the embodiment illustrated in FIG. 2. In the embodiment illustrated in FIG. 3, the neural network 252 is trained in the same way as the neural network 252 illustrated in FIG. 2. The communication of the process parameters between the central module 212 of the PLC 210, the input/output modules 214, 216 and the ML module 217 occurs, in the exemplary embodiment illustrated in FIG. 3, via the backplane bus of the PLC 210 (not illustrated in FIG. 3). The data that are each communicated in this case, and the entire method sequence for controlling the injection molding machine 100, corresponds here to the method sequence already described in connection with FIG. 2.

The changed control parameters are determined, in the exemplary embodiment illustrated in FIG. 3, in the ML module 217 via a further neural network (not illustrated in FIG. 3), as has already been explained in connection with the exemplary embodiment in FIG. 2 as an alternative embodiment for determining the changed control parameters.

In a further refinement of the exemplary embodiment illustrated in FIG. 3, the PLC 210 may comprise yet another application module in accordance with the present disclosure, which is in turn connected, via the backplane bus of the PLC 210, to the other modules 212, 214, 216, 217 of the PLC 210. This application module may, for example, be configured as a freely programmable application module. Here, the changed control parameters may then be determined in a programming language and/or programming environment that is advantageously applicable for mathematical, statistical and analytical algorithms and/or simulations (for example, using “Matlabe” and/or “Simulink®” software environment).

In the presently contemplated embodiment, the corresponding process parameters, the predecessor process parameters and the deviation of the predicted product mass from the target product mass are transmitted to this further application module and the changed control parameters are computed, estimated and/or determined there. These are then in turn transmitted, via the backplane bus of the PLC 210, to the central module 212 of the PLC 210, in order then to be transmitted via the field bus 218 to the injection molding machines 100. This then continues the production sequence with the changed control parameters or starts the production of a further product with these changed control parameters.

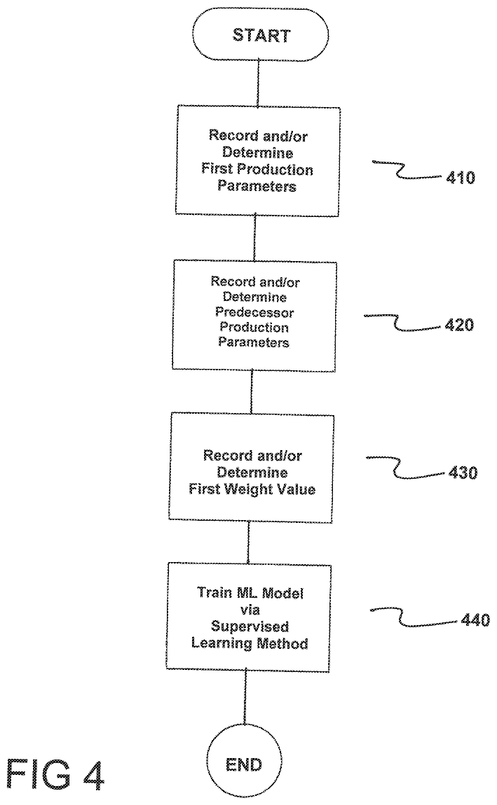

FIG. 4 is a flowchart of computer-implemented method for training a machine learning (ML) model 252 via an ML method, where the trained ML model 252 is configured to determine a predicted weight value of a product produced via an injection molding device 100.

The method comprises recording and/or determining first production parameters of the injection molding device 100 during production of a first product, as indicated in step 410.

Next, predecessor production parameters of the injection molding device 100 are recorded and/or determined during the production of at least one predecessor product, and at least one predecessor weight value of each at least one predecessor product, as indicated in step 420.

Next, a first weight value for the first product is recorded and/or determined, as indicated in step 430.

Next, the ML model 252 is trained with the first product parameters, the further product parameters, the at least one predecessor weight value and the first weight value via a supervised learning method, as indicated in step 440.

FIG. 5 is a flowchart of a control method for controlling production of a product via an injection molding device 100. The method comprises starting a production sequence for producing the product with the injection molding device 100 utilizing starting control variables for the injection molding device 100, as indicated in step 510.

Next, current production parameters are recorded and/or determined during the production sequence, as indicated in step 520.

Next, a product predicted weight value is determined utilizing a computer-implemented method, as indicated in step 530. Here, the comprises recording and/or determining production parameters of the injection molding device 100 during production of the product, recording and/or determining predecessor production parameters of the injection molding device 100 during production of at least one predecessor product, and each at least one predecessor weight value of the at least one predecessor product, and determining the predicted weight value of the product utilizing a trained ML model 252, the production parameters, the predecessor production parameters, the at least one predecessor weight value, and the at least some current production parameters as the production parameters.

Next, changed control variables are determined utilizing a deviation of the product predicted weight value from a product reference weight value, as indicated in step 540.

Next, the production sequence for producing the product is continued with the changed control variables, or starting a further production sequence for producing a further product utilizing the changed control variables, as indicated in step 550.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A computer-implemented method for training a machine learning (ML) model via an ML method, the trained ML model being configured to determine a predicted weight value of a product produced via an injection molding device, the method comprising:
recording and/or determining first production parameters of the injection molding device during production of a first product;
recording and/or determining predecessor production parameters of the injection molding device during the production of at least one predecessor product, and at least one predecessor weight value of each at least one predecessor product;
recording and/or determining a first weight value for the first product; and
training the ML model, via a supervised learning method, with the first product parameters, the further product parameters, the at least one predecessor weight value, and the first weight value.

2. The method as claimed in claim 1, wherein at least one of (i) at least one of the production parameters, the predecessor production parameters are at least one of recorded and determined at least in part via at least one of sensors of the injection molding device and control variables for the injection molding device and (ii) the first weight value of at least one of the first product and the at least one predecessor weight value of the at least one predecessor product is at least one of recorded and determined utilizing a weighing apparatus.

3. The method as claimed in claim 1, wherein at least one of the production parameters, the further production parameters, the first weight value, the at least one predecessor weight value is at least one of recorded and determined at least in part via a computer-implemented simulation of the injection molding device.

4. The method as claimed in claim 2, wherein at least one of the production parameters, the further production parameters, the first weight value, the at least one predecessor weight value is at least one of recorded and determined at least in part via a computer-implemented simulation of the injection molding device.

5. The method as claimed in claim 1, wherein at least one of the first weight value and the at least one predecessor weight value are each assigned to a finished product removed or removable from the injection molding device.

6. The method as claimed in claim 1, wherein at least one of the first weight value and the at least one predecessor weight value are configured as a time series of individual weight values.

7. A computer-implemented method for determining a predicted weight value of a product produced via an injection molding device, the method comprising:
recording and/or determining production parameters of the injection molding device during production of the product;
recording and/or determining predecessor production parameters of the injection molding device during production of at least one predecessor product, and each at least one predecessor weight value of the at least one predecessor product; and
determining the predicted weight value of the product utilizing a machine learning (ML) model trained via the method as claimed in claim 1 and utilizing the production parameters, the predecessor production parameters and the at least one predecessor weight value.

8. The computer-implemented method as claimed in claim 7, wherein the ML model is further trained utilizing the production parameters and a product weight of the manufactured product.

9. A control method for controlling production of a product via an injection molding device, the method comprising:
starting a production sequence for producing the product with the injection molding device utilizing starting control variables for the injection molding device;
recording and/or determining current production parameters during the production sequence;
determining a product predicted weight value using a computer-implemented method comprising:
recording and/or determining production parameters of the injection molding device during production of the product;
recording and/or determining predecessor production parameters of the injection molding device during production of at least one predecessor product, and each at least one predecessor weight value of the at least one predecessor product; and
determining the predicted weight value of the product utilizing a trained machine learning (ML) model, the production parameters, the predecessor production parameters, the at least one predecessor weight value, and
the at least some current production parameters as the production parameters;
determining changed control variables utilizing a deviation of the product predicted weight value from a product reference weight value; and
continuing the production sequence for producing the product with the changed control variables, or starting a further production sequence for producing a further product utilizing the changed control variables.

10. The control method as claimed in claim 9, wherein the control method is performed or is performable in real time.

11. A control system for controlling an injection molding device which is configured to produce a product, wherein the control system is configured to control the injection molding device via the control method as claimed in claim 9.

12. A control system for controlling an injection molding device which is configured to produce a product, wherein the control system is configured to control the injection molding device via the control method as claimed in claim 10.

13. The control system as claimed in claim 11, wherein the control system is configured to perform the control method in real time.

14. The control system as claimed in claim 11, wherein the control system comprises an edge device which configured to determine at least one (i) the product predicted weight value and (ii) the changed control variables.

15. The control system as claimed in claim 13, wherein the control system comprises an edge device which configured to determine at least one (i) the product predicted weight value and (ii) the changed control variables.

16. The control system as claimed in claim 11, wherein the control system comprises a programmable logic controller configured to control the injection molding device via a control method; and wherein the programmable logic controller comprises an application module configured to determine at least one of (i) the product predicted weight value and (ii) changed control variables.

17. The control system as claimed in claim 13, wherein the control system comprises a programmable logic controller configured to control the injection molding device via a control method; and wherein the programmable logic controller comprises an application module configured to determine at least one of (i) the product predicted weight value and (ii) changed control variables.

18. The control system as claimed in claim 14, wherein the control system comprises a programmable logic controller configured to control the injection molding device via a control method; and wherein the programmable logic controller comprises an application module configured to determine at least one of (i) the product predicted weight value and (ii) changed control variables.
